(19) United States
(12) Patent Application Publication
(10) Pub. No.: US 2026/0247071 A1
(43) Pub. Date: Aug. 20, 2026

(54) AUDIO MIXING FOR CONFERENCE DEVICE WITH MULTIPLE MICROPHONE ARRAYS

(71) Applicant: Cisco Technology, Inc., San Jose, CA (US)

(72) Inventors: Asbjorn Therkelsen, Nesbru (NO); Sindre Meringdal, Nittedal (NO); Oivind Stuan, Løten (NO)

(21) Appl. No.: 19/058,814

(22) Filed: Feb. 20, 2025

(51) Int. Cl. H04R 3/00; G10L 25/21; G10L 25/84; H04R 1/40

(52) U.S. Cl. CPC H04R 3/005; H04R 1/406; G10L 25/21; G10L 25/84; H04R 2410/01; H04R 2430/01

(57) ABSTRACT

A method is performed by a controller of a conference device that includes one or more microphone arrays each to form audio beams to convert audio in a room into beam signals. The method comprises: computing first-stage gains for the beam signals based on bandpass energies of the beam signals; computing second-stage gains for the beam signals based on the first-stage gains and bandpass signal-to-noise ratios of the beam signals; selecting preferred beam signals of the beam signals that have highest second-stage gains; computing transmit gains for the preferred beam signals; weighting the preferred beam signals with the transmit gains, to produce weighted preferred beam signals; and transmitting only the weighted preferred beam signals to a remote conference device.

### TECHNICAL FIELD

The present disclosure relates to controlling audio beams of a conference device.

### BACKGROUND

A conference device deployed in a video conference meeting room may include a video conference assembly (sometimes called a “video collaboration board”) that houses a microphone array, a video camera, and a video display. The conference device may further include an external ceiling microphone array spaced-apart from the video collaboration board. Each microphone array forms one or more audio beams pointing in different directions. In the conference device, an audio mixer receives audio detected by all of the audio beams, and selects a “best” audio beam from which to transmit audio to a remote conference device during a video conference session. Conventional audio beam selection uses simple energy-based audio beam selection, which may not select the best audio beam, and lead to a poor experience for a listener at the remote end. For example, when a meeting participant is located closer to the ceiling microphone than to the video collaboration board microphone array, but talks directly toward that microphone array, the audio beams of the ceiling microphone array may detect higher audio energy than those of the video collaboration board microphone array; however, the quality of audio detected by audio beams of the video collaboration board microphone array may be higher because of the directivity of high frequency energy originating from the talker.

### BRIEF DESCRIPTION OF THE DRAWINGS

FIG. 1 shows a top view of a room in which a conference device is deployed, according to an example embodiment.

FIG. 2 is a block diagram of a controller of the conference device, according to an example embodiment.

FIG. 3 shows audio signal flow between separated microphone arrays of the conference device, and a beam former and an audio mixer of the controller, according to an example embodiment.

FIG. 4 is a block diagram of the audio mixer, according to an example embodiment.

FIG. 5 is a flowchart of audio beam signal processing performed by a dual beam mixer of the audio mixer, according to an example embodiment.

FIG. 6 is a flowchart of a method of audio mixing performed by a controller of a video conference device equipped with one or more microphone arrays, according to an example embodiment.

FIG. 7 shows successive multi-stage processing performed by the audio mixer on successive audio frames of audio beam signals, according to an example embodiment.

FIG. 8 illustrates a hardware block diagram of a computing device that may perform functions associated with operations discussed herein, according to an example embodiment.

### DETAILED DESCRIPTION

### Overview

In an embodiment, a method is performed by a controller of a conference device that includes one or more microphone arrays each to form audio beams to convert audio in a room into beam signals. The method comprises: computing first-stage gains for the beam signals based on bandpass energies of the beam signals; computing second-stage gains for the beam signals based on the first-stage gains and bandpass signal-to-noise ratios of the beam signals; selecting preferred beam signals of the beam signals that have highest second-stage gains; computing transmit gains for the preferred beam signals; weighting the preferred beam signals with the transmit gains, to produce weighted preferred beam signals; and transmitting only the weighted preferred beam signals to a remote conference device.

### Example Embodiments

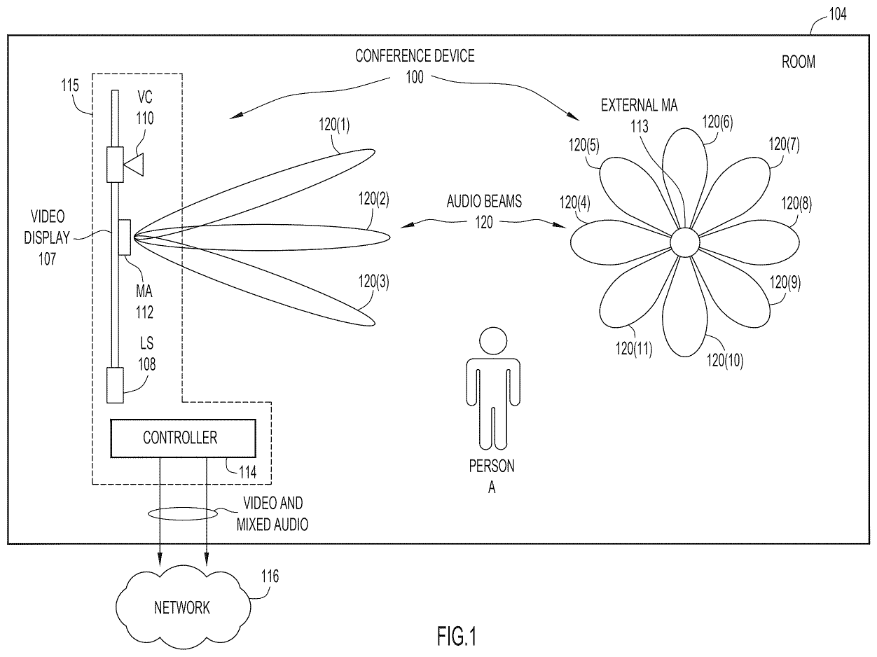

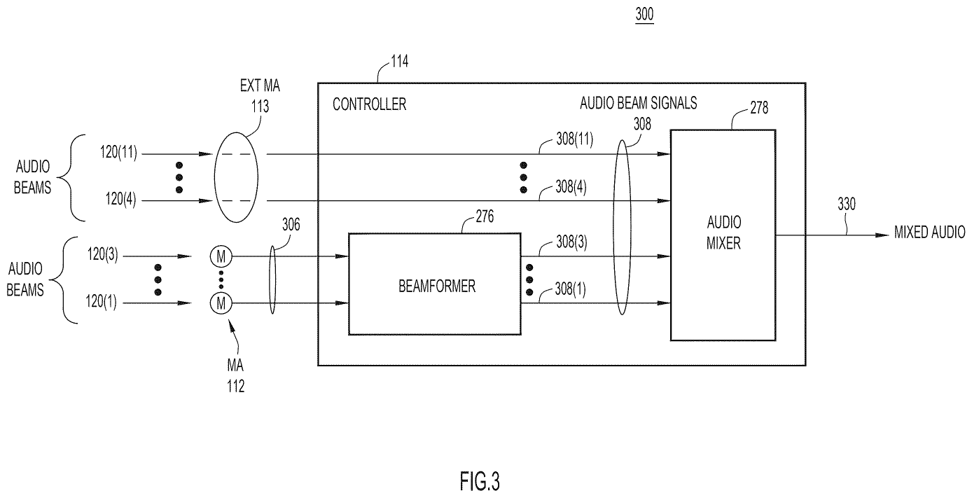

FIG. 1 is an illustration of an example conference device 100 equipped with separated microphone arrays and that implements audio mixing of audio beams from each microphone array. In the example, conference device 100 (also referred to as a “conference system” and an “endpoint device”) is deployed in a room 104 (more generally, any physical space) occupied by a participant A (or multiple participants) during a video conference session (also referred to as an “online meeting” or a “video meeting”). FIG. 1 shows a top view of room 104. Conference device 100 includes components that are physically distributed around room 104. FIG. 3 described below shows signal connections between some of the components.

Conference device 100 includes a video display 107, a loudspeaker (LS) 108, a video camera (VC) 110, a microphone array (MA) 112, an external (EXT) MA 113, and a controller 114 that communicates with and controls the foregoing components of the conference device. Controller 114 also communicates (e.g., exchanges data packets) with a network 116 using any known or hereafter developed communication protocols, such as, a Transmission Control Protocol (TCP)/Internet Protocol (IP) (TCP/IP), for example. Video display 107, loudspeaker 108, MA 112, and controller 114 may be incorporated into a housing or assembly 115 (also referred to as a “video conference board”) that is adjacent to an end wall of room 104. On the other hand, EXT MA 113 may be centrally mounted in a ceiling of room 104 and spaced-apart from assembly 115 by over several feet. Moreover, EXT MA is movable relative to assembly 115. Therefore, EXT MA 113 may be positioned anywhere in room 104. Conference device 100 may be configured with known/predetermined positions of VC 110, MA 112, and EXT MA 113 relative to one another in room 104. The positions may be entered into conference device 100 by a user, or established during a sound calibration procedure, for example.

VC 110 captures video in a field-of-view (FOV) of room 104 that encompasses participant A. VC 110 provides the video to controller 114. By way of example, MA 112 forms audio beams 120(1)-120(3) (also referred to as “first audio beams”) that radiate outwardly from the MA into room 104 to detect audio in the room. MA 112 may form more or less than three audio beams. By way of example, EXT MA 113 forms audio beams 120(4)-120(11) (also referred to as “second audio beams”), which radiate outwardly from the EXT MA into room 104, to detect audio in the room. EXT MA 113 may form more or less than eight audio beams. Audio beams 120(4)-120(11) may be elevation beams arranged radially (i.e., separated from each other in azimuth) around a central axis of EXT MA 113. For example, audio beams 120(4)-120(11) may represent a predetermined set of fixed audio beams that cover room 104 in 360° azimuth, and 90° elevation. Audio beams 120(1)-120(11) are collectively referred to as “audio beams 120.” Each aforementioned audio beam 120(i) is a receive audio beam that detects audio in room 104 and provides the detected audio to controller 114.

At a high level, conference device 100 captures video of participants in room 104. Conference device 100 receives audio detected by audio beams 120(1)-120(3) and 120(4)-120(11) from MA 112 and EXT MA 113, respectively. Conference device 100 performs multi-stage gain processing on the audio to produce gain results. Based on the gain results, conference device 100 selects preferred audio beams, derives transmit gains, and applies the transmit gains to audio from the preferred audio beams to produce weighted preferred audio. During a video conference session, conference device 100 transmits video and only the weighted preferred audio as mixed audio to a remote conference device.

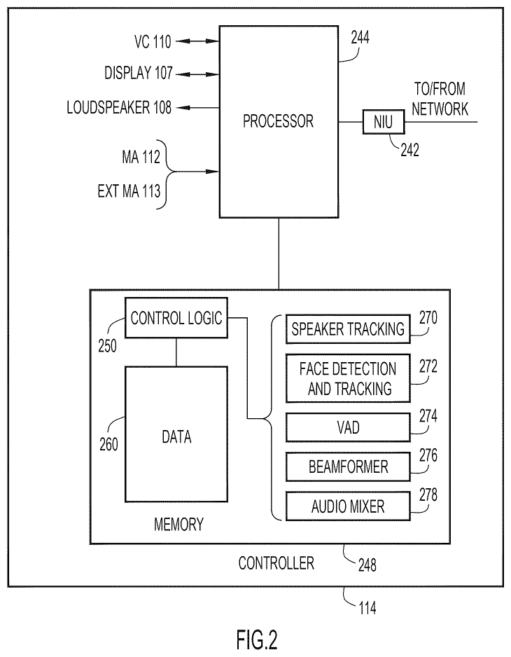

FIG. 2 is a block diagram of controller 114 according to an embodiment. There are numerous possible configurations for controller 114 and FIG. 2 is meant to be an example. Controller 114 includes a network interface (I/F) unit (NIU) 242, a processor 244, and memory 248. The aforementioned components of controller 114 may be implemented in hardware, software, firmware, and/or a combination thereof. NIU 242 is, for example, an Ethernet card or other interface device that allows the controller 114 to communicate over network 116. NIU 242 may include wired and/or wireless connection capability.

Processor 244 may include a collection of microcontrollers and/or microprocessors, for example, each configured to execute respective software instructions stored in the memory 248. The collection of microcontrollers may include, for example: a video controller to receive, send, and process video signals related to video display 107 and VC 110; an audio processor to receive, send, and process audio signals related to loudspeaker 108, MA 112, and EXT MA 113; and a high-level controller to provide overall control. Portions of memory 248 (and the instructions therein) may be integrated with processor 244. In the transmit direction, processor 244 processes audio/video of participants captured by MA 112 and EXT MA 113/VC 110, encodes the captured audio/video into data packets using audio/video codecs, and causes the encoded data packets to be transmitted to network 116. In the receive direction, processor 244 decodes audio/video from data packets received from network 116 and causes the audio/video to be presented to participants via loudspeaker 108/video display 107. As used herein, the terms “audio” and “sound” are synonymous and used interchangeably. Also, “voice” and “speech” are synonymous and used interchangeably.

The memory 248 may comprise read only memory (ROM), random access memory (RAM), magnetic disk storage media devices, optical storage media devices, flash memory devices, electrical, optical, or other physical/tangible (e.g., non-transitory) memory storage devices. Thus, in general, the memory 248 may comprise one or more computer readable storage media (e.g., a memory device) encoded with software comprising computer executable instructions and when the software is executed (by the processor 244) it is operable to perform the operations described herein. For example, the memory 248 stores or is encoded with instructions for control logic 250 perform operations described herein.

Control logic 250 includes logic to process the audio and video. In addition, memory 248 stores data 260 used and generated by control logic 250. Control logic 250 includes logic for speaker tracking 270 (also referred to as “talker tracking”), face detection and tracking 272, and voice activity detection (VAD) 274. Conference device 100 employs any known or hereafter developed speaker tracking, face detection and tracking, and VAD techniques. Control logic 250 further includes logic for a beamformer 276 and an audio mixer 278 both described below in connection with FIGS. 3-7.

VAD 274 determines whether voice energy is present (or not present) in audio detected by audio beams 120, and provides a VAD flag to indicate the presence or absence of the voice energy. Speaker tracking 270 detects a talker (e.g., participant A) in room 104 based on audio detected by audio beams 120. To do this, speaker tracking detects voice energy uttered by the talker, and computes a talker position relative to a microphone array (e.g., one or both of MA 112 and/or EXT MA 113). The talker position includes an angle and a distance to the talker relative to the microphone array(s). In an embodiment, speaker tracking 270 additionally determines/measures a length of time that a current talker has been talking continuously (e.g., without an interruption over an extended period, such as multiple audio frames), and records information indicative of the length of time (also referred to as a “talk time”).

Face detection and tracking 272 processes video of room 104 captured by VC 110 to detect faces of individuals (e.g., the face of participant A), and a face position of each detected face. The face position includes an angle and a distance of the face relative to VC 110. In an embodiment, conference device 100 may correlate a face position (based on video) against a talker position (based on audio) of a current talker to ensure accuracy of the talker position while the talk time is being measured.

FIG. 3 shows example audio signal flow 300 from MA 112 and EXT MA 113 to beamformer 276 and audio mixer 278. MA 112 includes microphones (Ms) that concurrently detect audio energy to produce parallel (i.e., concurrent) microphone signals 306 each from a corresponding one of the microphones. Beamformer 276 performs audio beamforming on microphone signals 306 to form audio beams 120(1)-120(3), and converts the audio energy detected by each audio beam to corresponding ones of audio beam signals 308(1)-308(3) (also referred to as “first beam signals”). For example, audio beam signal 308(1) conveys the particular audio energy (i.e., the beam-specific audio) detected by audio beam 120(1), audio beam signal 308(2) conveys the beam-specific audio detected by audio beam 120(2), and so on. Beamformer 276 maintains a mapping of audio beams 120(1)-120(3) to corresponding ones of audio beam signals 308(1)-308(3) (i.e., the beam-specific audio) produced by the audio beams. Beamformer 276 provides to audio mixer 278 audio beam signals 308(1)-308(3) respectively representative of the audio energy detected by audio beams 120(1)-120(3).

EXT MA 113 forms audio beams 120(4)-120(11) that detect audio and convert the audio to corresponding ones of audio beam signals 308(4)-308(11) (also referred to as “second beam signals”). In an example, EXT MA 113 may turn on or turn off selected ones of audio beams 120(4)-120(11) responsive to commands supplied to the EXT MA by controller 114. Audio beam signals 308(4)-308(11) are also referred to as “beam-specific” audio beam signals. EXT MA 113 provides to audio mixer 278 audio beam signals 308(4)-308(11) respectively representative of the energy detected by audio beams 120(4)-120(11). Controller 114 maintains a mapping of audio beam signals 308(1)-308(11) (collectively referred to as “audio beam signals 308”) to audio beams 120(1)-120(11). Each audio beam signal may include successive audio frames (e.g., 20 ms audio frames) that convey the audio energy detected by the corresponding audio beam.

Audio mixer 278 mixes or combines into mixed audio 330 weighted audio in preferred ones of audio beam signals 308(1)-308(11) (i.e., audio detected by selected ones of audio beams 120(1)-120(11)). Audio mixer 278 transmits mixed audio 330 to network 116 during a video conference session.

As used herein, an audio beam 120(i) and its corresponding audio beam signal 308(i) may be referred to interchangeably, depending on context. For example, a gain for audio beam signal 308(2) may also be referred to as a gain for audio beam 120(2). Additionally, an “audio beam signal” may be referred to simply as a “beam signal.”

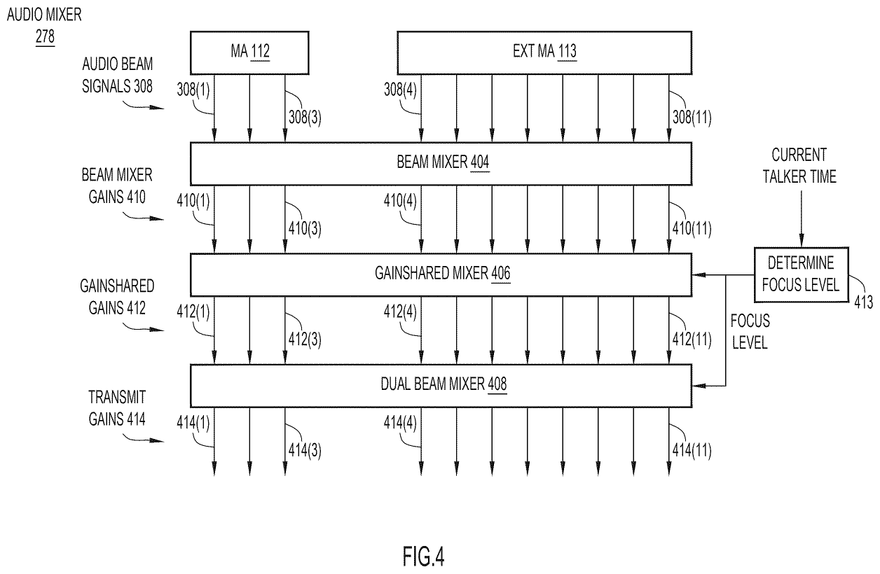

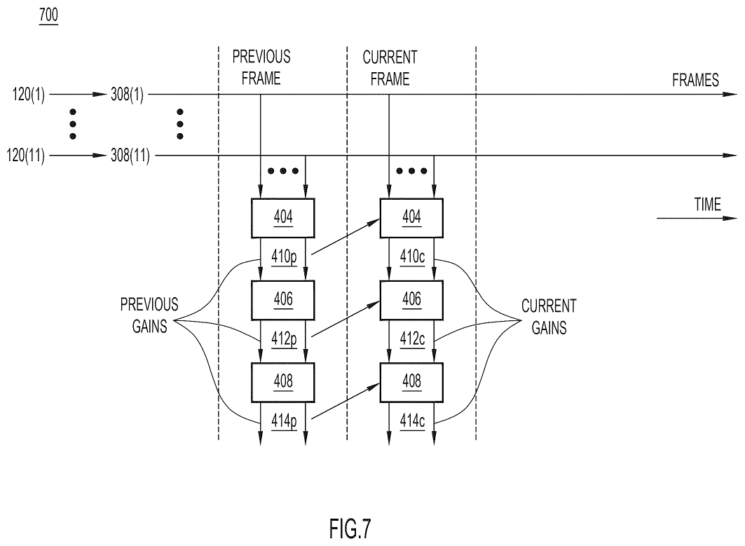

FIG. 4 is a block diagram of audio mixer 278 according to an embodiment. Audio mixer 278 includes multiple (successive) gain stages, including a beam mixer 404, a gainshared mixer 406, and a dual beam mixer (DBM) 408. Each gain stage processes gains for beam signals 308(1)-308(11) (and thus for audio beams 220(1)-220(11)), concurrently. As mentioned above, audio beam signals 308(1)-308(11) respectively include sequential audio frames. Beam mixer 404, gainshared mixer 406, and DBM 408 process the sequential audio frames (and/or gains for the sequential audio frames) one frame at a time (i.e., on a frame-by-frame basis), to produce gains for each frame. The example of FIG. 4 includes a single beam mixer. Another example includes a separate beam mixer for each microphone array. Beam mixer 404, gainshared mixer 406, and DBM 408 store the gains for each frame into a history of the gains over many frames. Using the history, beam mixer 404, gainshared mixer 406, and DBM 408 produce current gains for a current frame, based in part on previous gains for a previous frame. In this way, beam mixer 404, gainshared mixer 406, and DBM 408 may smooth or average their gains over time. Time-sequenced frame processing is described below in connection with FIG. 7.

Successive gain stage processing is now described with continued reference to FIG. 4. MA 112 and EXT MA 113 respectively provide audio beam signals 308(1)-308(3) and 308(4)-308(11) to beam mixer 404, in parallel. Beam mixer 404 performs beam mixer (i.e., first-stage) gain processing on audio beam signals 308(1)-308(11) individually and concurrently, to produce beam mixer gains 410(1)-410(11) (collectively referred to as “beam mixer gains 410” or “first-stage gains”) for corresponding ones of audio beam signals 308(1)-308(11) (and for corresponding ones of audio beams 120(1)-120(11)).

The beam mixer gain processing includes the following. First, beam mixer 404 individually bandpass filters audio beam signals 308(1)-308(11) to produce corresponding individual bandpass energies (also referred to as “bandlimited energies”) for the audio beam signals. For example, beam mixer 404 bandpass filters the energy in each audio beam signal 308(i) in a frequency band from 2-8 kHz to produce a corresponding bandpass energy. Second, beam mixer 404 computes each beam mixer gain 410(i) for the current frame based on the bandpass energy and a previous beam mixer gain for a previous frame, using an exponential sliding window, as follows:

$$Beam mixer gain = ALPHA \cdot bandpass energy + ( 1 - ALPHA ) \cdot previous beam mixer gain ,$$

where ALPHA has a first value when the beam mixer gain is increasing, and a second value when the beam mixer gain is decreasing.

Beam mixer 404 provides beam mixer gains 410 (i.e., the first-stage gains) to gainshared mixer 406. Gainshared mixer 406 also receives audio beam signals 308.

Gainshared mixer 406 performs gainshared (i.e., second-stage) gain processing of beam mixer gains 410(1)-410(11) individually and concurrently, to produce gainshared gains 412(1)-412(11) (collectively referred to as “gainshared gains 412” and “second-stage gains”) for corresponding ones of audio beam signals 308(1)-308(11) (and corresponding ones of audio beams 120(1)-120(11)). The gainshared gain processing includes the following. Gainshared mixer 406 estimates a total noise energy (i.e., a broadband noise energy) for an entire frequency band of each audio beam signal 308(i). Next, gainshared mixer 406 computes a (normalized) bandpass (i.e., bandlimited) signal-to-noise ratio (SNR) (BSNR) for each audio beam signal 308(i) as a ratio of the bandpass energy to the total noise energy (i.e., bandpass energy/total noise energy) for each audio beam signal 308(i).

Audio mixer 278 receives information that indicates a length of time a current talker has been talking. At 413, audio mixer 278 sets a “focus level” based on that length of time. The focus level increases as the length of time the current talker has been talking increases, and vice versa. For example, when a new talker starts to talk such that the length of time is short, the focus level is set to 1. After some time, when the same speaker continuous to talk, the focus level is set to 2, then to 3, and so on, as the length of time increases.

Next, gainshared mixer 406 computes each gainshared gain 412(i) for the current frame, based on beam mixer gain 410(i) for the current frame, the focus level, and a previous gainshared gain for the previous frame, using an exponential sliding window, as follows:

$$Gainshared gain = ALPHA \cdot ( beam mixer gain \cdot {( normalized BSNR )}^{focus level} ) + ( 1 - ALPHA ) \cdot previous gainshared gain .$$

Gainshared mixer 406 provides gainshared gains 412 (i.e., the second-stage gains) to DBM 408.

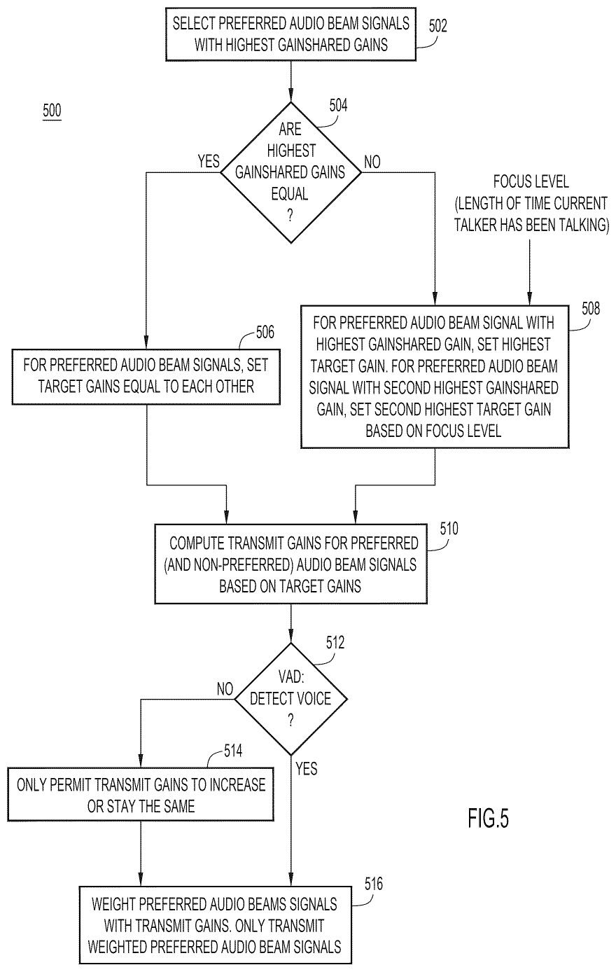

DBM 408 performs DBM (third-stage) gain processing based on gainshared gains 412(1)-412(11) individually and concurrently, to produce transmit or transmit gains 414(1)-414(11) (collectively referred to as “transmit gains 414” and “final gains”) for corresponding audio beam signals 308(1)-308(11) (and corresponding ones of audio beams 120(1)-120(11)). The dual beam gain processing is described in connection with FIG. 5.

FIG. 5 is a flowchart of example DBM processing 500, performed by DBM 408.

At 502, DBM 408 selects two preferred audio beam signals (of audio beam signals 308) that have the two highest gainshared gains (of gainshared gains 412). Specifically, DBM 408 selects first and second preferred audio beam signals with first and second gainshared gains that are the highest. The preferred audio beam signals correspond to preferred audio beams, including first and second preferred audio beams. All remaining audio beam signals (and the corresponding audio beams) may be referred to as “non-preferred” audio beam signals (and corresponding non-preferred audio beams). In an example in which DBM 408 selects preferred audio beam signals 308(3) and 308(11), then audio beam signals 308(1), 308(2), and 308(4)-308(10) remain non-preferred audio beams.

DBM 408 may impose additional rules for selecting the preferred audio beam signals/audio beams. For example, assuming audio beams 120(1) and 120(3) have highest and second highest gainshared gains, an additional rule may prevent selection of audio beam 120(3) as one of the preferred audio beams in order to avoid undesired audio reflections.

At 504, DBM 408 determines whether the first and second gainshared gains for the first and second preferred audio beam signals are equal to each other within a predetermined tolerance. When they are equal, flow proceeds to 506. When they are not equal, flow proceeds to 508. As described below, operations 506 and 508 set targets gains for the preferred audio beam signals depending on whether their gainshared gains are equal, i.e., based on a relationship between the magnitudes of the first and second gainshared gains.

At 506, DBM 408 sets first and second target gains for the first and second preferred audio beam signals equal to each other, and equal to a highest level. For example, DBM 408 sets the first and second target gains equal to 1, which is the highest level. Flow proceeds to 510.

At 508, assume the first and second gainshared gains for the first and second preferred audio signals are the highest and the second highest gainshared gains (i.e., the first gainshared gain is greater than the second gainshared gain). In that case, DBM 408 sets the first and second target gains as follows. DBM 408 sets the first target gain (i.e., the highest target gain) higher than the second target gain (i.e., the second highest target gain). In an example, DBM 408 sets the first target gain equal to 1. On the other hand, DBM 408 sets the second target gain to a value that is less than 1, and that is/varies based on the focus level. For example, the second target gain decreases as the focus level increases, and vice versa. As a result, the second target gain decreases as the length of time that the same talker has been talking increases. In a specific example, the second target level is 0.75, 0.5, and 0.25 for respective focus levels 1, 2, and 3, although other values may be used in other examples.

For the non-preferred audio beam signals (and corresponding audio beams), DBM 408 sets respective target gains equal to a low value (e.g., 0.1) that is less than the first and second target gains for the first and second preferred audio beam signals.

At 510, DBM 408 computes a transmit gain 414(i) for each audio beam signal of audio beam signals 308 (and corresponding ones of audio beams 120) based on the target gain and a previous transmit gain using an exponential sliding window:

$$Transmit gain = ALPHA \cdot target gain + ( 1 - ALPHA ) \cdot previous transmit gain ,$$

where ALPHA has a first value when the transmit gain is increasing, and a second value when the transmit gain is decreasing.

Thus, DBM 408 computes first and second preferred transmit gains for the first and second preferred audio beams, and computes non-preferred transmits gains for the non-preferred audio beams.

Next operations 512 and 514 are optional. Operations 512 and 514 use VAD 274 and additional rules to control when transmit gains 414 may be permitted to change over time. At 512, using VAD 274, DBM 408 determines whether voice is present. When voice is present, DBM 408 permits transmit gains 414 to increase and decrease over time, i.e., no restriction is placed on accepting changed transmits gains from one frame to the next. For example, when a current transmit gain for a current frame differs from a previous transmit gain for a previous frame, DBM 408 adopts the current transmit gain. Flow proceeds to 516. When voice is not present, flow proceeds to 514.

At 514, DBM 408 only permits transmit gains 414 to increase or remain constant over time. That is, DBM 408 does not permit transmit gains 414 to decrease over time. For example, DBM 408 only adopts a current transmit gain for a current frame when a previous transmit gain for a previous frame is less than the current transmit gain (i.e., only when the current transmit gain has increased relative to the previous transmit gain). Otherwise, DBM 408 rejects the (current) transmit gain and adopts the previous transmit gain. Flow proceeds to 516.

At 516, controller applies transmit gains 414 to corresponding ones of audio beam signals 308 (e.g., multiplies the levels of the audio signals by the transmit gains) to produce weighted audio beam signals. That is, DBM 408 weights audio beam signals 308 with transmit gains 414. This includes weighting the first and second preferred audio beam signals with respective first and second preferred transmit gains, to produce first and second weighted preferred audio beam signals. DBM 408 transmits only the first and second weighted preferred audio beam signals (as mixed audio 330) to a remote conference device. DBM 408 does not transmit the weighted non-preferred audio beam signals in mixed audio 330.

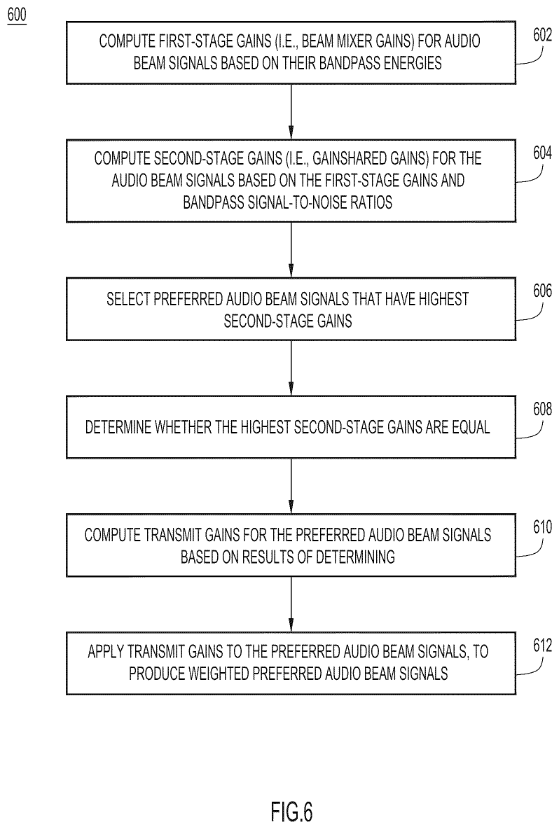

FIG. 6 is a flowchart of an example method 600 of audio mixing for a video conference device equipped with one or more microphone arrays each to form respective audio beams to convert audio in a room into respective audio beam signals (also referred to simply as “beam signals”). In an example, the one or more microphone arrays include a first microphone array to form first audio beams that convert audio into first audio beam signals, and a second microphone array to form second audio beams that convert audio into second audio beam signals. In the example, the first audio beam signals and the second audio beam signals are collectively referred to as “audio beam signals.” Method 600 may be performed when the conference device has established a video conference session with a remote conference device over a network, for example.

At 602, the controller processes the audio beam signals to compute first-stage gains (i.e., beam mixer gains) for the audio beam signals based on bandpass energies of the audio beam signals.

At 604, the controller computes second-stage gains (i.e., gainshared gains) for the audio beam signals based on the first-stage gains and bandpass SNRs of the audio beam signals.

At 606, the controller selects preferred audio beam signals of the audio beam signals that have highest second-stage gains.

At 608, the controller determines whether the highest second-stage gains are equal.

At 610, the controller computes transmit gains for the preferred audio beam signals based on results of determining.

At 612, the controller weights the preferred audio beam signals with the transmit gains, to produce weighted preferred audio beam signals. During the video conference session, the controller causes only the weighted preferred audio beam signals to be transmitted to the remote conference device.

FIG. 7 shows example successive (time-sequenced) multi-stage processing 700 performed by audio mixer 278 on successive audio frames of audio beam signals 308, including a previous frame followed by a current frame. During the previous frame, beam mixer 404, gainshared mixer 406, and DBM 408 process audio beam signals 308 of the previous frame, to produce previous beam mixer gains 410p, gainshared gains 412p, and transmit gains 414p. The previous gains are recorded for the current (next) frame. Then, during the current frame, beam mixer 404, gainshared mixer 406, and DBM 408 process audio beam signals 308 of the current frame, to produce current beam mixer gains 410c, gainshared gains 412c, and transmit gains 414c based on the respective previous gains generated for the previous frame. The process repeats for the next frame, and so on. In summary, audio mixer 278 computes the first-stage gains, the second-stage gains, and the transmit gains for a current audio frame based on respective gain results computed for a previous audio frame.

In summary, embodiments presented herein implement an audio mixer that selects a preferred audio beam or a combination of preferred audio beams in a conference device equipped with multiple microphone arrays separated from each other in a room. The audio mixer applies a beam mixer to audio beams formed by each microphone array, to produce beam mixer gains. A gainshared mixer of the audio mixer applies to the beam mixer gains a bandpass SNR and a focus level based on how long a current talker has been talking, to produce gainshared gains. A dual beam mixer of the audio mixer selects preferred audio beams that have highest gainshared gains. The dual beam mixer weights audio detected by the preferred audio beams with transmit gains depending on the focus level.

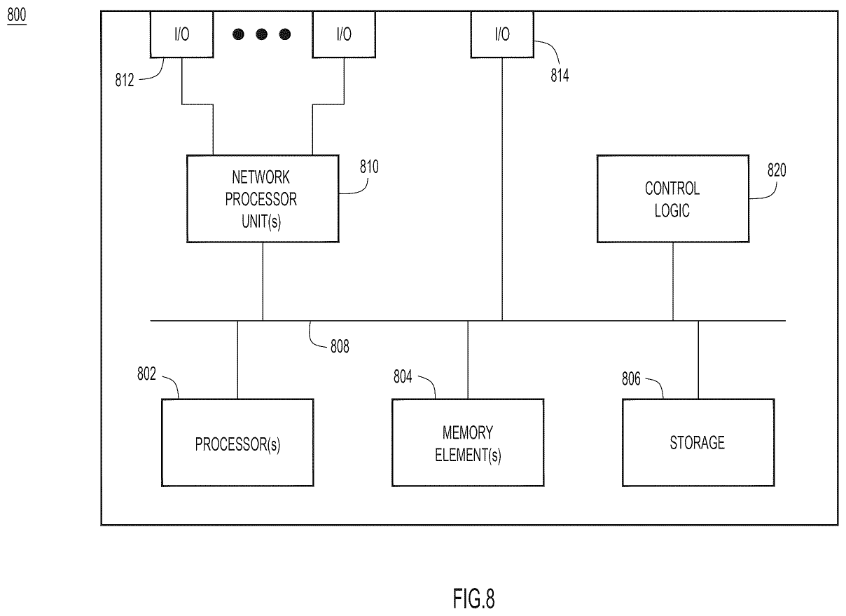

Referring to FIG. 8, FIG. 8 illustrates a hardware block diagram of a computing device 800 that may perform functions associated with operations discussed herein in connection with the techniques depicted in FIGS. 1-7. In various embodiments, a computing device or apparatus, such as computing device 800 or any combination of computing devices 800, may be configured as any entity/entities as discussed for the techniques depicted in connection with FIGS. 1-7 in order to perform operations of the various techniques discussed herein. For example, computing device 800 may represent conference device 100.

In at least one embodiment, the computing device 800 may be any apparatus that may include one or more processor(s) 802, one or more memory element(s) 804, storage 806, a bus 808, one or more network processor unit(s) 810 interconnected with (e.g., coupled to) one or more network input/output (I/O) interface(s) 812, one or more I/O interface(s) 814, and control logic 820. In various embodiments, instructions associated with logic for computing device 800 can overlap in any manner and are not limited to the specific allocation of instructions and/or operations described herein.

In at least one embodiment, processor(s) 802 is/are at least one hardware processor configured to execute various tasks, operations and/or functions for computing device 800 as described herein according to software and/or instructions configured for computing device 800. Processor(s) 802 (e.g., a hardware processor) can execute any type of instructions associated with data to achieve the operations detailed herein. In one example, processor(s) 802 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 804 and/or storage 806 is/are configured to store data, information, software, and/or instructions associated with computing device 800, and/or logic configured for memory element(s) 804 and/or storage 806. For example, any logic described herein (e.g., control logic 820) can, in various embodiments, be stored for computing device 800 using any combination of memory element(s) 804 and/or storage 806. Note that in some embodiments, storage 806 can be consolidated with memory element(s) 804 (or vice versa), or can overlap/exist in any other suitable manner.

In at least one embodiment, bus 808 can be configured as an interface that enables one or more elements of computing device 800 to communicate in order to exchange information and/or data. Bus 808 can be implemented with any architecture designed for passing control, data and/or information between processors, memory elements/storage, peripheral devices, and/or any other hardware and/or software components that may be configured for computing device 800. In at least one embodiment, bus 808 may be implemented as a fast kernel-hosted interconnect, potentially using shared memory between processes (e.g., logic), which can enable efficient communication paths between the processes.

In various embodiments, network processor unit(s) 810 may enable communication between computing device 800 and other systems, entities, etc., via network I/O interface(s) 812 (wired and/or wireless) to facilitate operations discussed for various embodiments described herein. In various embodiments, network processor unit(s) 810 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 800 and other systems, entities, etc. to facilitate operations for various embodiments described herein. In various embodiments, network I/O interface(s) 812 can be configured as one or more Ethernet port(s), Fibre Channel ports, any other I/O port(s), and/or antenna(s)/antenna array(s) now known or hereafter developed. Thus, the network processor unit(s) 810 and/or network I/O interface(s) 812 may include suitable interfaces for receiving, transmitting, and/or otherwise communicating data and/or information in a network environment.

I/O interface(s) 814 allow for input and output of data and/or information with other entities that may be connected to computing device 800. For example, I/O interface(s) 814 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 820 can include instructions that, when executed, cause processor(s) 802 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 820) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 804 and/or storage 806 can store data, software, code, instructions (e.g., processor instructions), logic, parameters, combinations thereof, and/or the like used for operations described herein. This includes memory element(s) 804 and/or storage 806 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi 6®), IEEE 802.16 (e.g., Worldwide Interoperability for Microwave Access (WiMAX)), Radio-Frequency Identification (RFID), Near Field Communication (NFC), Bluetooth™, mm. wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’nomenclature (e.g., one or more element(s)).

In some aspects, the techniques described herein relate to a method performed by a controller of a conference device that includes one or more microphone arrays each to form audio beams to convert audio in a room into beam signals, the method including: computing first-stage gains for the beam signals based on bandpass energies of the beam signals; computing second-stage gains for the beam signals based on the first-stage gains and bandpass signal-to-noise ratios of the beam signals; selecting preferred beam signals of the beam signals that have highest second-stage gains; computing transmit gains for the preferred beam signals; weighting the preferred beam signals with the transmit gains, to produce weighted preferred beam signals; and transmitting only the weighted preferred beam signals to a remote conference device.

In some aspects, the techniques described herein relate to a method, wherein computing the second-stage gains includes: estimating total noise energies of the beam signals; and computing the bandpass signal-to-noise ratios as ratios of the bandpass energies to the total noise energies.

In some aspects, the techniques described herein relate to a method, further including: detecting a talker in the room and a length of time that the talker has been talking, wherein computing the second-stage gains includes increasing and decreasing the second-stage gains in correspondence with the length of time the talker has been talking.

In some aspects, the techniques described herein relate to a method, further including: determining whether the highest second-stage gains are equal, wherein computing the transmit gains includes computing the transmit gains based on results of determining.

In some aspects, the techniques described herein relate to a method, further including: setting target gains for the preferred beam signals based on the results of determining, wherein computing the transmit gains includes computing the transmit gains based on the target gains.

In some aspects, the techniques described herein relate to a method, wherein: when the highest second-stage gains are equal, setting the target gains includes setting the target gains equal to each other.

In some aspects, the techniques described herein relate to a method, wherein: when the highest second-stage gains are not equal, setting the target gains includes setting a highest target gain and a second highest target gain for a first preferred beam signal and a second preferred beam signal that have a highest second-stage gain and a second highest second-stage gain, respectively.

In some aspects, the techniques described herein relate to a method, further including: detecting a talker in the room and a length of time that the talker has been talking; and increasing and decreasing the second highest target gain in correspondence with the length of time the talker has been talking.

In some aspects, the techniques described herein relate to a method, further including: detecting whether voice energy is present in the beam signals; when the voice energy is present, permitting the transmit gains to increase and decrease over time; and when the voice energy is not present, only permitting the transmit gains to increase or remain constant over time.

In some aspects, the techniques described herein relate to a method, wherein: the beam signals respectively include sequences of audio frames; and the method further includes computing the first-stage gains, the second-stage gains, and the transmit gains in each audio frame.

In some aspects, the techniques described herein relate to a method, wherein: computing the first-stage gains, the second-stage gains, and the transmit gains includes computing the first-stage gains, the second-stage gains, and the transmit gains in a current audio frame based on respective gain results computed in a previous audio frame.

In some aspects, the techniques described herein relate to a method, wherein: the beam signals respectively include sequences of audio frames; and computing each selection gain includes computing a current selection gain for a current audio frame based on a bandpass energy for the current audio frame and a first gain computed for a previous audio frame.

In some aspects, the techniques described herein relate to a method, wherein the one or more microphone arrays include: a first microphone array to form first audio beams of the audio beams to produce first beam signals of the beam signals; and a second microphone array spaced-apart from the first microphone array and used to form second audio beams of the audio beams to produce second beam signals of the beam signals.

In some aspects, the techniques described herein relate to an apparatus including: one or more microphone arrays to form audio beams used to convert audio in a room into beam signals; a network interface unit to communicate with a network; and a controller coupled to the one or more microphone arrays and the network interface unit, wherein the controller configured to perform: computing first-stage gains for the beam signals based on bandpass energies of the beam signals; computing second-stage gains for the beam signals based on the first-stage gains and bandpass signal-to-noise ratios of the beam signals; selecting preferred beam signals of the beam signals that have highest second-stage gains; computing transmit gains for the preferred beam signals; weighting the preferred beam signals with the transmit gains, to produce weighted preferred beam signals; and causing only the weighted preferred beam signals to be transmitted to a remote conference device.

In some aspects, the techniques described herein relate to an apparatus, wherein the controller is configured to perform computing the second-stage gains by: estimating total noise energies of the beam signals; and computing the bandpass signal-to-noise ratios as ratios of the bandpass energies to the total noise energies.

In some aspects, the techniques described herein relate to an apparatus, wherein the controller is further configured to perform: detecting a talker in the room and a length of time that the talker has been talking, wherein the controller is configured to perform computing the second-stage gains by increasing and decreasing the second-stage gains in correspondence with the length of time the talker has been talking.

In some aspects, the techniques described herein relate to an apparatus, wherein the controller is further configured to perform: determining whether the highest second-stage gains are equal, wherein computing the transmit gains includes computing the transmit gains based on results of determining.

In some aspects, the techniques described herein relate to a non-transitory computer readable medium encoded with instructions that, when executed by a controller of a conference device that includes one or more microphone arrays each to form audio beams to convert audio in a room into beam signals, cause the controller to perform: computing first-stage gains for the beam signals based on bandpass energies of the beam signals; computing second-stage gains for the beam signals based on the first-stage gains and bandpass signal-to-noise ratios of the beam signals; selecting preferred beam signals of the beam signals that have highest second-stage gains; computing transmit gains for the preferred beam signals; weighting the preferred beam signals with the transmit gains, to produce weighted preferred beam signals; and causing only the weighted preferred beam signals to be transmitted to a remote conference device.

In some aspects, the techniques described herein relate to a non-transitory computer readable medium, wherein the instructions to cause the controller to perform computing the second-stage gains include instructions to cause the controller to perform: estimating total noise energies of the beam signals; and computing the bandpass signal-to-noise ratios as ratios of the bandpass energies to the total noise energies.

In some aspects, the techniques described herein relate to a non-transitory computer readable medium, further including instructions to cause the controller to perform: determining whether the highest second-stage gains are equal, wherein the instructions to cause the controller to perform computing the transmit gains include instructions to cause the controller to perform computing the transmit gains based on results of determining.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method performed by a controller of a conference device that includes one or more microphone arrays each to form audio beams to convert audio in a room into beam signals, the method comprising:
computing first-stage gains for the beam signals based on bandpass energies of the beam signals;
computing second-stage gains for the beam signals based on the first-stage gains and bandpass signal-to-noise ratios of the beam signals;
selecting preferred beam signals of the beam signals that have highest second-stage gains;
computing transmit gains for the preferred beam signals;
weighting the preferred beam signals with the transmit gains, to produce weighted preferred beam signals; and
transmitting only the weighted preferred beam signals to a remote conference device.

2. The method of claim 1, wherein computing the second-stage gains includes:
estimating total noise energies of the beam signals; and
computing the bandpass signal-to-noise ratios as ratios of the bandpass energies to the total noise energies.

3. The method of claim 1, further comprising:
detecting a talker in the room and a length of time that the talker has been talking,
wherein computing the second-stage gains includes increasing and decreasing the second-stage gains in correspondence with the length of time the talker has been talking.

4. The method of claim 1, further comprising:
determining whether the highest second-stage gains are equal,
wherein computing the transmit gains includes computing the transmit gains based on results of determining.

5. The method of claim 4, further comprising:
setting target gains for the preferred beam signals based on the results of determining,
wherein computing the transmit gains includes computing the transmit gains based on the target gains.

6. The method of claim 5, wherein:
when the highest second-stage gains are equal, setting the target gains includes setting the target gains equal to each other.

7. The method of claim 5, wherein:
when the highest second-stage gains are not equal, setting the target gains includes setting a highest target gain and a second highest target gain for a first preferred beam signal and a second preferred beam signal that have a highest second-stage gain and a second highest second-stage gain, respectively.

8. The method of claim 7, further comprising:
detecting a talker in the room and a length of time that the talker has been talking; and
increasing and decreasing the second highest target gain in correspondence with the length of time the talker has been talking.

9. The method of claim 1, further comprising:
detecting whether voice energy is present in the beam signals;
when the voice energy is present, permitting the transmit gains to increase and decrease over time; and
when the voice energy is not present, only permitting the transmit gains to increase or remain constant over time.

10. The method of claim 1, wherein:
the beam signals respectively include sequences of audio frames; and
the method further includes computing the first-stage gains, the second-stage gains, and the transmit gains in each audio frame.

11. The method of claim 10, wherein:
computing the first-stage gains, the second-stage gains, and the transmit gains includes computing the first-stage gains, the second-stage gains, and the transmit gains in a current audio frame based on respective gain results computed in a previous audio frame.

12. The method of claim 1, wherein:
the beam signals respectively include sequences of audio frames; and
computing each selection gain includes computing a current selection gain for a current audio frame based on a bandpass energy for the current audio frame and a first gain computed for a previous audio frame.

13. The method of claim 1, wherein the one or more microphone arrays include:
a first microphone array to form first audio beams of the audio beams to produce first beam signals of the beam signals; and
a second microphone array spaced-apart from the first microphone array and used to form second audio beams of the audio beams to produce second beam signals of the beam signals.

14. An apparatus comprising:
one or more microphone arrays to form audio beams used to convert audio in a room into beam signals;
a network interface unit to communicate with a network; and
a controller coupled to the one or more microphone arrays and the network interface unit, wherein the controller configured to perform:
computing first-stage gains for the beam signals based on bandpass energies of the beam signals;
computing second-stage gains for the beam signals based on the first-stage gains and bandpass signal-to-noise ratios of the beam signals;
selecting preferred beam signals of the beam signals that have highest second-stage gains;
computing transmit gains for the preferred beam signals;
weighting the preferred beam signals with the transmit gains, to produce weighted preferred beam signals; and
causing only the weighted preferred beam signals to be transmitted to a remote conference device.

15. The apparatus of claim 14, wherein the controller is configured to perform computing the second-stage gains by:
estimating total noise energies of the beam signals; and
computing the bandpass signal-to-noise ratios as ratios of the bandpass energies to the total noise energies.

16. The apparatus of claim 14, wherein the controller is further configured to perform:
detecting a talker in the room and a length of time that the talker has been talking,
wherein the controller is configured to perform computing the second-stage gains by increasing and decreasing the second-stage gains in correspondence with the length of time the talker has been talking.

17. The apparatus of claim 14, wherein the controller is further configured to perform:
determining whether the highest second-stage gains are equal,
wherein computing the transmit gains includes computing the transmit gains based on results of determining.

18. A non-transitory computer readable medium encoded with instructions that, when executed by a controller of a conference device that includes one or more microphone arrays each to form audio beams to convert audio in a room into beam signals, cause the controller to perform:
computing first-stage gains for the beam signals based on bandpass energies of the beam signals;
computing second-stage gains for the beam signals based on the first-stage gains and bandpass signal-to-noise ratios of the beam signals;
selecting preferred beam signals of the beam signals that have highest second-stage gains;
computing transmit gains for the preferred beam signals;
weighting the preferred beam signals with the transmit gains, to produce weighted preferred beam signals; and
causing only the weighted preferred beam signals to be transmitted to a remote conference device.

19. The non-transitory computer readable medium of claim 18, wherein the instructions to cause the controller to perform computing the second-stage gains include instructions to cause the controller to perform:
estimating total noise energies of the beam signals; and
computing the bandpass signal-to-noise ratios as ratios of the bandpass energies to the total noise energies.

20. The non-transitory computer readable medium of claim 18, further comprising instructions to cause the controller to perform:
determining whether the highest second-stage gains are equal,
wherein the instructions to cause the controller to perform computing the transmit gains include instructions to cause the controller to perform computing the transmit gains based on results of determining.
